(19) United States
(12) Patent Application Publication
(10) Pub. No.: US 2026/0049747 A1
(43) Pub. Date: Feb. 19, 2026

(54) LIQUID-COOLED CONDENSER

(71) Applicant: UFI INNOVATION CENTER S.R.L., Ala, Trento (IT)

(72) Inventor: Giorgio GIRONDI, Ala, Trento (IT)

(73) Assignee: UFI INNOVATION CENTER S.R.L., Ala, Trento (IT)

(21) Appl. No.: 19/101,362

(22) PCT Filed: Jul. 14, 2023
(86) PCT No.: PCT/IB2023/057213

§ 371 Date: Feb. 5, 2025

(30) Foreign Application Priority Data
Aug. 5, 2022 (IT) 102022000016788

(51) Int. Cl. F25B 39/04; F28D 9/00; F28D 21/00

(52) U.S. Cl. CPC F25B 39/04; F28D 9/005; F25B 2339/045; F28D 2021/0084

(57) ABSTRACT

A liquid-cooled condenser of a vehicle cooling system includes a refrigerant inlet and outlet mouths, through which the refrigerant fluid flows, and a liquid inlet mouth and a liquid outlet mouth through which the liquid flows. The liquid-cooled condenser includes upper and lower plate-like end elements, wherein the mouths are on the plate-like end elements. Intermediate plate-like elements in their mutual stacking define a refrigerant region, in which the refrigerant fluid flows, having refrigerant supply sections, in fluidic communication with the refrigerant inlet and outlet mouths. Transverse refrigerant sections, and a liquid region, into which the liquid flows, include liquid supply sections, in fluidic communication with the liquid inlet and outlet mouths. Transverse liquid sections alternate with the transverse refrigerant sections. A tubular element extending into the outlet refrigerant supply section, includes transverse section smaller than a transverse section of the outlet refrigerant supply section, forming a condensation gap.

### CROSS-REFERENCE TO RELATED APPLICATIONS

This application is a National Stage Application of PCT/IB2023/057213, filed Jul. 14, 2023, which claims benefit of priority to Italian Patent Application No. 102022000016788 filed on Aug. 5, 2022, and which applications are incorporated herein by reference. To the extent appropriate, a claim of priority is made to each of the above disclosed applications.

### FIELD OF APPLICATION

The present invention relates to a liquid-cooled condenser.

In particular, the present invention belongs to the automotive field.

### PRIOR ART

Liquid-based condenser solutions are known from the prior art, which in fact find specific application in a vehicle, in particular in the cooling system of a vehicle.

Further in detail, the liquid-cooled condenser is suitable for carrying out a heat exchange operation between two fluids, that is between a refrigerant and a coolant liquid. In fact, the liquid-cooled condenser is used to carry out an action of condensing of a refrigerant fluid which is at least partially in a gas state due to the heat exchange with a fluid to be cooled, for example due to the heat exchange which occurs in appropriate evaporators between said refrigerant fluid and the coolant fluid of the batteries of electric or hybrid vehicles. As a result of the heat exchange which takes place in the liquid-cooled condenser, the refrigerant fluid condenses, giving up heat to the coolant liquid. For simplicity, in the following paragraphs, the term “liquid” refers to said coolant liquid.

In particular, “refrigerant fluid” means a fluid having a chemical composition which allows it to undergo a phase change at temperature and pressure values compatible with the operation of the cooling system.

In the automotive field, it is known the use of liquid-based condensers as intersection elements between a system in which the refrigerant fluid circulates and a system in which the liquid circulates.

Obtaining a liquid-cooled condenser, suitable for carrying out an efficient heat exchange between the refrigerant fluid and the liquid, is desired in the sector. In fact, a liquid-cooled condenser suitable for carrying out an efficient heat exchange improves both the efficiency of the system in which the refrigerant fluid circulates and the efficiency of the system in which the liquid circulates.

### SUMMARY OF THE INVENTION

The need is therefore strongly felt to provide a liquid-cooled condenser which fulfills said need.

Object of the present invention is to provide a liquid-cooled condenser having a duct layout that improves the heat exchange and in particular the condensation of the refrigerant fluid.

Such an object is achieved by a liquid-cooled condenser.

### BRIEF DESCRIPTION OF THE DRAWINGS

Further features and advantages of the invention will become apparent from the description provided below of preferred exemplary embodiments thereof, given by way of non-limiting indication, with reference to the accompanying drawings, in which:

FIGS. 1a and 1b show two partially sectioned perspective views in separate parts of the liquid-cooled condenser according to the present invention, according to a preferred embodiment;

FIG. 2 shows a partially sectioned perspective view in semi-separated parts of the liquid-cooled condenser in FIGS. 1a and 1b;

FIG. 3a 3b and 3c show, in perspective, the liquid-cooled condenser in FIGS. 1a and 1b, sectioned according to different section planes.

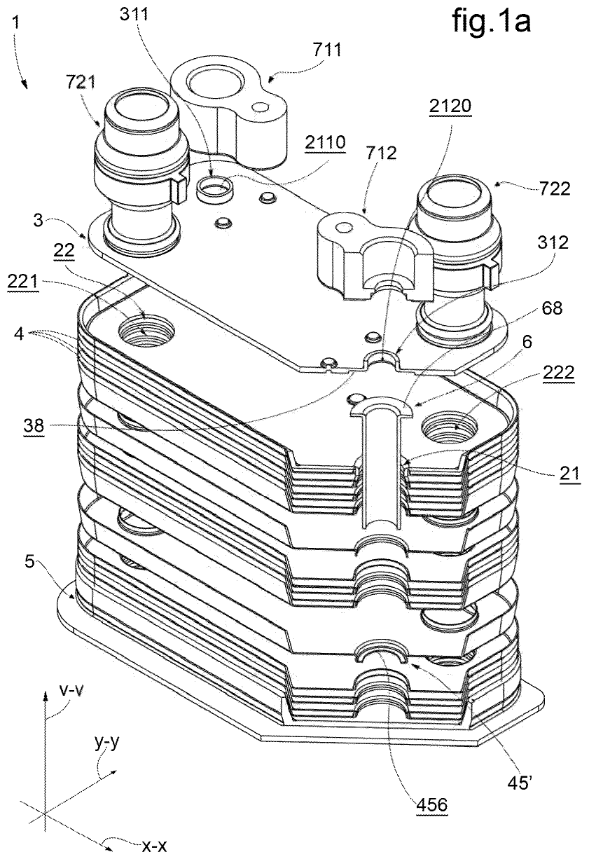

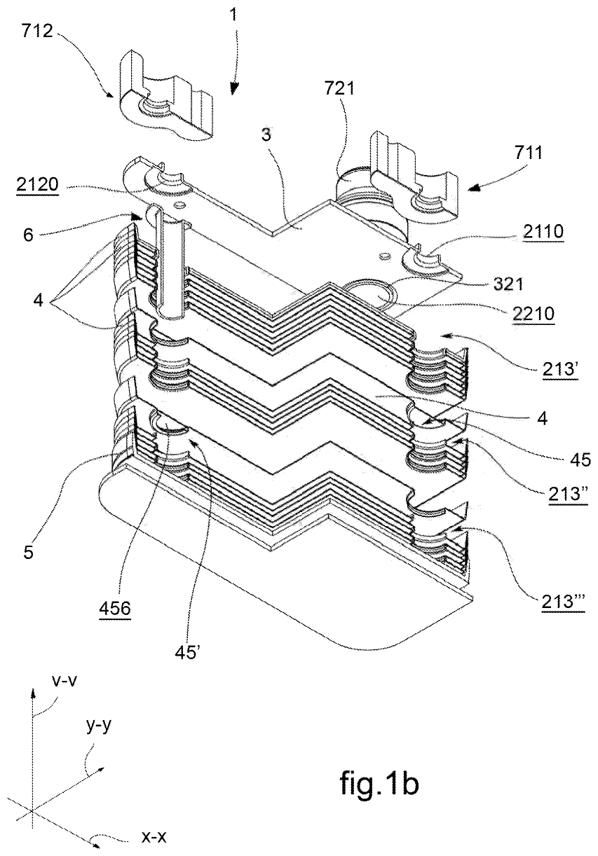

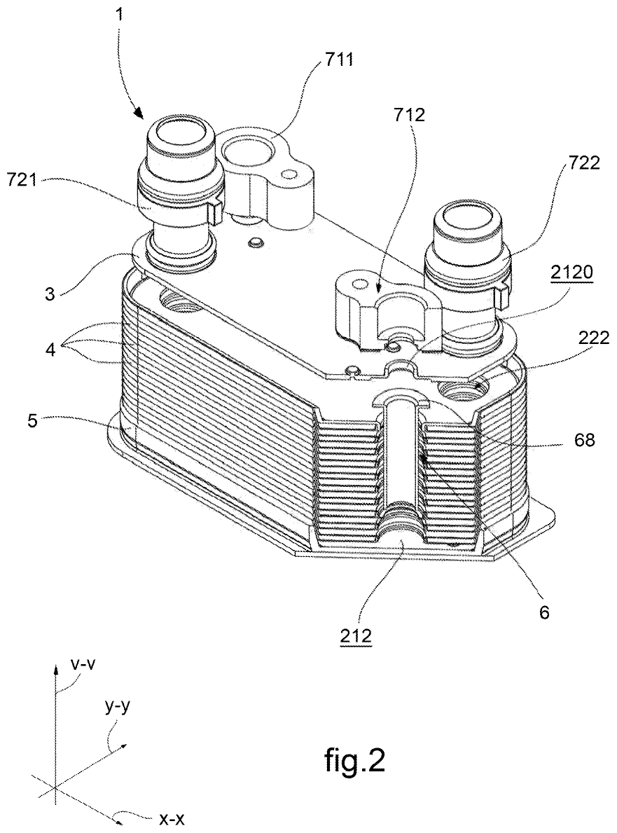

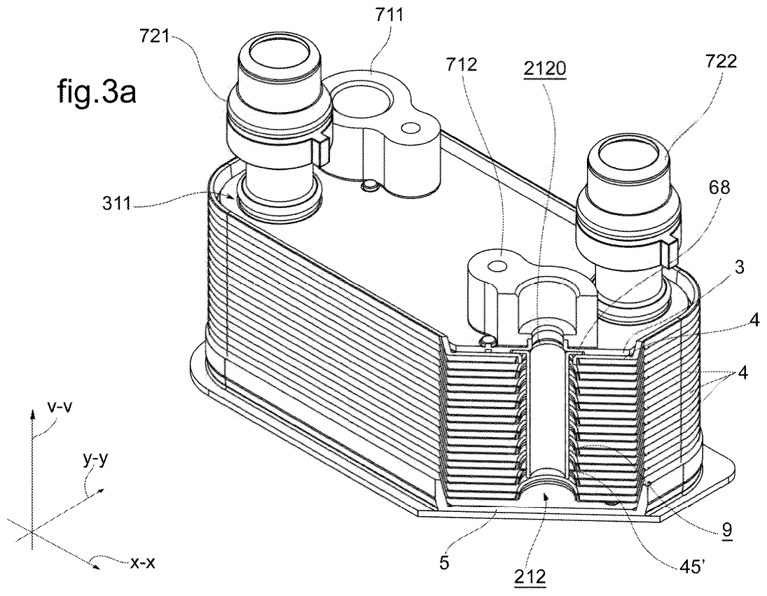

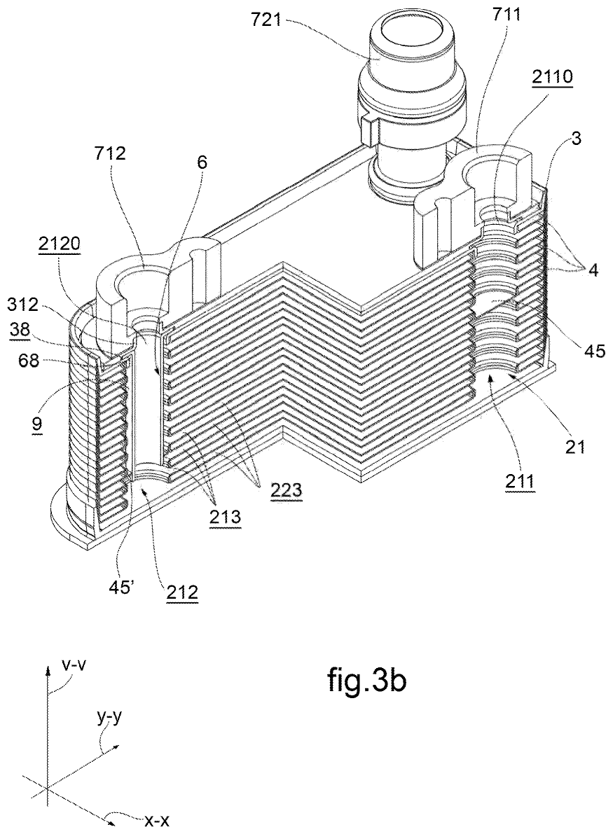

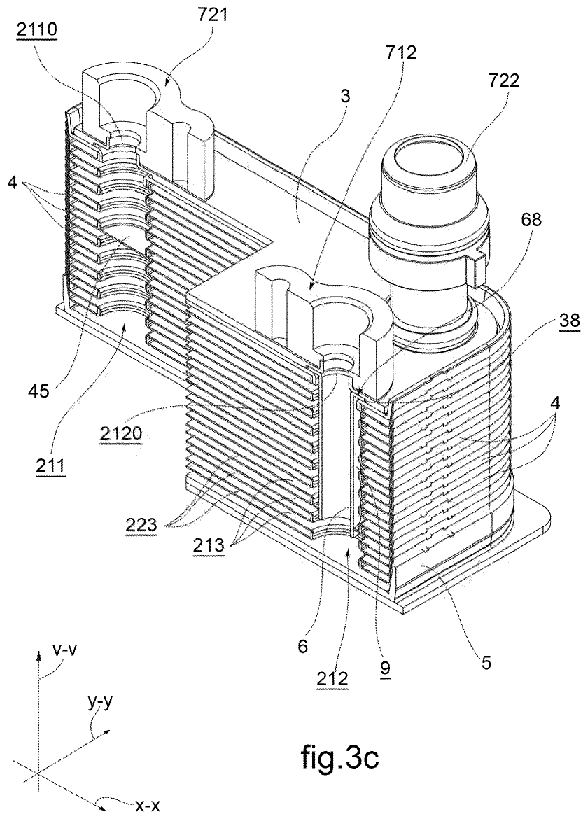

### DETAILED DESCRIPTION

With reference to the accompanying Figures, reference number 1 indicates a liquid-cooled condenser 1 of a cooling system of a vehicle, according to the present invention.

The liquid-cooled condenser 1 is suitable for carrying out an action of condensing of a refrigerant fluid circulating in the cooling system by means of heat exchange with a liquid.

In fact, both a refrigerant fluid and a liquid flow in the liquid-cooled condenser 1.

The refrigerant fluid, in the liquid-cooled condenser, undergoes a phase transformation being subjected to condensation.

By way of example, refrigerant fluid means one of the operating fluids normally used in a refrigeration cycle such as, for example, R134a, R744, R290, R718, R717, R1234yfa or R1234y. According to a preferred embodiment, the refrigerant fluid is of the R1234yf type.

Preferably, the refrigerant fluid reaches the liquid-cooled condenser in an at least partially gas state.

According to a preferred embodiment, the refrigerant fluid reaches the liquid-cooled condenser 1 after having flowed into a compressor and, even earlier into an evaporator.

Preferably, the refrigerant fluid reaches the liquid-cooled condenser in a totally gas state.

According to a preferred embodiment, the liquid is a water and glycol-based solution.

According to the present invention, the liquid-cooled condenser 1 comprises a refrigerant inlet mouth 2110 and a refrigerant outlet mouth 2120 through which the refrigerant fluid flows in and out.

Furthermore, according to the present invention, the liquid-cooled condenser 1 comprises a liquid inlet mouth 2210 and a liquid outlet mouth 2220 through which the liquid flows in and out.

The liquid-cooled condenser 1 comprises plate-like end elements 3, 5 and intermediate plate-like elements 4.

The liquid-cooled condenser 1 is obtained by joining said plate-like elements. In particular, the plate-like elements are packed together along a preferential stacking direction.

In particular, the liquid-cooled condenser 1 extends in height with respect to a first axis V-V and transversely with respect to two transverse axes X-X, Y-Y, lying on the same imaginary plane, orthogonal to the axis V-V.

Preferably, the plate-like elements extend substantially in parallel to said first axis V-V. That is, the plate-like elements extend transversely with respect to the two transverse axes X-X, Y-Y.

Preferably, the plate-like end elements 3, 5 are axially spaced apart along the first axis V-V. According to a preferred embodiment, a plate-like end element 3 is referred to as upper, while the other plate-like end element 5 is referred to as lower.

According to the present invention, the mouths 2110, 2120, 2210, 2220 are obtained on said plate-like end elements 3, 5.

According to the present invention, the refrigerant inlet mouth 2110, the outlet refrigerant mouth 2120, the liquid inlet mouth 2210 and the liquid outlet mouth 2220 are obtained on said plate-like end elements 3, 5.

Preferably, all the mouths 2110, 2120, 2210, 2220 are obtained on the upper plate-like element 3.

Preferably, the refrigerant inlet mouth 2110, the outlet refrigerant mouth 2120, the liquid inlet mouth 2210 and the liquid outlet mouth 2220 are obtained on said upper plate-like end element 3.

According to the present invention, the intermediate plate-like elements 4 are specially shaped, delimiting, in the mutual stacking thereof, a refrigerant region 21 in which the refrigerant fluid flows and a liquid region 22 in which the liquid flows.

Preferably, the intermediate plate-like elements 4 are obtained by means of mechanical molding, cutting and/or folding operations carried out from a sheet.

Preferably, the intermediate plate-like elements 4 are made of aluminum alloy.

The refrigerant region 21 comprises refrigerant supply sections 211, 212, inlet and outlet sections, respectively, in fluidic communication with the refrigerant inlet mouth 2110 and with the refrigerant outlet mouth 2120, and transverse refrigerant sections 213.

Preferably, the refrigerant supply sections 211, 212 are aligned along the axis V-V at the refrigerant inlet mouth 2110 and the refrigerant outlet mouth 2120, respectively. Preferably, the inlet refrigerant supply section 211 and the outlet refrigerant supply section 212 are aligned along the axis V-V at the refrigerant inlet mouth 2110 and the refrigerant outlet mouth 2120.

Preferably, said transverse refrigerant sections 213 extend mutually parallel to each other.

The liquid region 22 comprises liquid supply sections 221, 222, inlet and outlet sections, respectively, in fluidic communication with the liquid inlet mouth 2210 and with the liquid outlet mouth 2220, and transverse liquid sections 223.

Preferably, the liquid supply sections 221, 222 are aligned along the axis V-V at the liquid inlet mouth 2210 and the liquid outlet mouth 2220, respectively. Preferably, the inlet liquid supply section 221 and the outlet liquid supply section 222 are aligned along the axis V-V at the liquid inlet mouth 2210 and the liquid outlet mouth 2220.

Preferably, said transverse liquid sections 223 extend mutually parallel to each other.

The transverse liquid sections 223 are positioned alternately with the transverse refrigerant sections 213.

According to a preferred embodiment, the transverse refrigerant sections 213 comprise respective turbulator elements.

According to a preferred embodiment, the transverse liquid sections 223 comprise respective turbulator elements.

Preferably, both the transverse refrigerant sections 213 and the transverse liquid sections 223 comprise respective turbulator elements.

According to a preferred embodiment, the transverse refrigerant sections 213 have a greater height than the transverse liquid sections 223.

According to a preferred embodiment, the transverse refrigerant sections 213 have a greater height than the transverse liquid sections 223 by 20%.

According to a preferred embodiment, the transverse refrigerant sections 213 have a height from 2.2 millimeters to 2.6 millimeters, preferably equal to about 2.4 millimeters.

According to a preferred embodiment, the transverse liquid sections 223 have a height from 1.8 millimeters to 2.2 millimeters, preferably equal to about 2.0 millimeters.

According to a preferred embodiment, the intermediate plate-like elements 4 are shaped to present specific openings, the alignment of which along the axis V-V defines the aforementioned supply sections.

According to a preferred embodiment, at least one of the intermediate plate-like elements 4 comprises a plug portion 45 positioned transversely to an inlet refrigerant supply section 211 to divert the flow of the refrigerant fluid, preferably in a transverse direction with respect to the axis V-V.

Preferably, at least one of the intermediate plate-like elements 4 comprises a plug portion 45′positioned transversely to an outlet refrigerant supply section 212 so that, in the transverse refrigerant sections 213, an inlet refrigerant region 213′, an intermediate refrigerant region 213″, and an outlet refrigerant region 213″′ are identified.

Preferably, the inlet refrigerant region 213′, the intermediate refrigerant region 213″ and the outlet refrigerant region 213″′ each comprise at least three transverse refrigerant sections 213. Preferably, the inlet refrigerant region 213′, the intermediate refrigerant region 213″ and the outlet refrigerant region 213″′ each comprise the same number of transverse refrigerant sections 213.

Preferably, the inlet refrigerant region 213′comprises a greater number of transverse refrigerant sections 213 with respect to the intermediate refrigerant region 213″ and the outlet refrigerant region 213′″.

According to a preferred embodiment, the refrigerant fluid flows into the refrigerant region 21 so as to have flows in opposite transverse directions between respective operating regions 213′, 213″, 213′″.

According to a preferred embodiment, the refrigerant fluid flows into the refrigerant region 21 so as to have flows in opposite transverse respectively between the inlet refrigerant region 213′ and the intermediate refrigerant region 213″ and between the intermediate refrigerant region 213″ outlet refrigerant region 213′″.

According to a preferred embodiment, the flow of the refrigerant fluid in the inlet refrigerant region 213′and in the outlet refrigerant region 213″′ have the same transverse direction with respect to the intermediate refrigerant region 213″.

Furthermore, according to the present invention, the liquid-cooled condenser 1 comprises a tubular element 6 which extends into the outlet refrigerant supply section 212, defining a fluidic duct therein.

Furthermore, according to the present invention, the transverse section of the tubular element 6 is lower than the cross section of the outlet refrigerant supply section 212, identifying a condensation gap 9.

Preferably, said condensation gap 9 is an annular duct.

Preferably, said annular duct, in section, has the shape of a circular crown.

Preferably, the cross section of the tubular element 6 is lower than the internal diameter of the refrigerant outlet mouth 2120.

According to a preferred embodiment, the refrigerant fluid inside the tubular element 6 flows in a liquid state towards the refrigerant outlet mouth 2120, while the refrigerant fluid inside the condensation gap 9 flows in the opposite direction, being at least partially in a gas state.

According to a preferred embodiment, the tubular element 6 comprises a radial collar 68.

According to a preferred embodiment, the radial collar 68 extends further than the section of the outlet refrigerant supply section 212.

Preferably, the radial collar 68 has a greater external diameter than the internal diameter of the outlet refrigerant supply section 212. According to a preferred embodiment, said radial collar 68 is positioned between a plate-like end element 3, 5 and an intermediate plate-like element 4.

Preferably, the radial collar 68 has a greater external diameter than the internal diameter of the refrigerant outlet mouth 2120.

According to a preferred embodiment, the plate-like end element 3, 5 comprises a recess 38 in which the radial collar 68 is housed.

Preferably, the recess 38 is in the upper plate-like end element 3. Preferably, the recess 38 is in the upper plate-like end element 3 on the face facing the adjacent intermediate plate-like element 4.

According to a preferred embodiment, a plate-like end element 3, 5 comprises two or more plates and the radial collar 68 is positioned between two plates comprised in said plate-like end element.

Preferably, the radial collar 68 has an external diameter greater than the internal diameter of the refrigerant outlet mouth 2120.

According to a preferred embodiment, one of the plates comprised in the plate-like end element 3, 5 comprises a recess 38 in which is housed the radial collar 68.

According to a preferred embodiment, the recess 38 is shaped to house and align along the axis V-V, the tubular element 6 in the outlet refrigerant supply section 212.

According to a preferred embodiment, the plug portion 45′, housed in the outlet refrigerant supply section 212, comprises a tubular element opening 456 through which the tubular element 6 extends.

According to a preferred embodiment, the tubular element 6 engages the plug portion 45′.

According to a preferred embodiment, the tubular element 6 is operatively connected to the plug portion 45′, preferably to said tubular element opening 456, to fluidically connect the outlet refrigerant region 213″′ to the refrigerant outlet mouth 2120.

According to a preferred embodiment, the tubular element 6 engages the edge of the tubular element opening 456 comprised in the plug portion 45′.

Preferably, said tubular element 6 is operatively connected to the plug portion 45′by means of a brazing joint.

According to a preferred embodiment, the plug portion 45′has an annular shape housing in the condensation gap 9.

According to a preferred embodiment, the inside of the tubular element 6 fluidically connects the outlet refrigerant region 213″′ to the refrigerant outlet mouth 2120.

According to a preferred embodiment, the tubular element 6 extends along the axis V-V beyond the plug portion 45′into the outlet refrigerant supply section 212 in fluidic communication with the outlet refrigerant region 213′'.

According to a preferred embodiment, the plug portion 45, 45′is comprised, in one piece, in the respective intermediate plate-like element 4.

Preferably, an intermediate plate-like element 4 comprises the plug portion 45 suitable for closing the inlet refrigerant supply section 211.

Preferably, an intermediate plate-like element 4 comprises the plug portion 45′suitable for closing the outlet refrigerant supply section 212, that is, it is suitable for delimiting the condensation gap 9.

In other words, at least one, preferably two, intermediate plate-like element 4 are shaped comprising the plug portion 45.

According to a preferred embodiment, the plate-like end elements 3, 5, the intermediate plate-like elements 4, and the tubular element 6 are mutually joined to each other by means of a brazing operation, preferably in a vacuum furnace.

According to a preferred embodiment, the liquid-cooled condenser 1 comprises inlet and outlet refrigerant connection members 711, 712, operatively connected to the plate-like end element 3, 5 at the refrigerant inlet mouth 2110 and at the refrigerant outlet mouth 2120.

According to a preferred embodiment, the liquid-cooled condenser 1 comprises inlet and outlet liquid connection members 721, 722, operatively connected to the plate-like end element 3, 5 at the liquid inlet mouth 2210 and at the liquid outlet mouth 2220.

According to a preferred embodiment, the connection members 711, 712, 721, 722, the plate-like end elements 3, 5, the intermediate plate-like elements 4, and the tubular element 6 are mutually joined to each other by means of a single brazing operation, preferably in a vacuum furnace.

According to a preferred embodiment, the plate-like end element 3, 5, comprises a protruding connection collar 312, positioned around the refrigerant outlet mouth 2120, which is engageable by the outlet refrigerant connection member 712.

According to a preferred embodiment, the plate-like end element 3, 5 comprises, about the refrigerant inlet mouth 2110 and the refrigerant outlet mouth 2120, a respective connection collar 311, 312, vertically protruding and engageable by a respective refrigerant connection member 711, 712.

According to a preferred embodiment, each collar facilitates the positioning of the respective connection member during the assembly of the liquid-cooled condenser 1.

According to a preferred embodiment, the liquid-cooled condenser 1 is placeable, in the vehicle and, in place, in a vertical configuration, that is, in a position in which said axis V-V and therefore the axis of the tubular element 6 are oriented in a substantially horizontal direction with respect to the ground plane.

According to a preferred embodiment, the liquid-cooled condenser 1 is placeable, in the vehicle and in place, in a position in which said axis V-V and therefore the axis of the tubular element 6 are parallel to a ground plane, or to the road on which the vehicle is moving.

Furthermore, according to a preferred embodiment, the liquid-cooled condenser 1 installed in a vertical position has the tubular element 6 in a lower geodetic position with respect to the inlet refrigerant supply section 211.

Innovatively, the liquid-cooled condenser largely fulfills the purpose of the present invention, overcoming issues which are typical of the prior art.

Advantageously, in fact, the liquid-cooled condenser has fluid passages suitable for making the heat exchange particularly efficient.

Advantageously, the path of the refrigerant fluid is optimized as best as possible, to favor the condensation of the refrigerant fluid.

Advantageously, the fluid path of the refrigerant fluid is optimized to better manage the phase transition thereof.

Advantageously, the tubular element comprises a radial collar being housable in a special recess provided at the interface between the plate-like end element and the intermediate plate-like element. Advantageously, the radial collar facilitates the integration of the tubular element into the condenser and provides a centering system which is useful to ensure the correct positioning of the tubular element inside the outlet refrigerant supply section and an adequate control over the annular extension of the condensation gap.

Advantageously, the tubular element comprises an end portion which protrudes with respect to the tubular element opening comprised in the plug portion suitable for closing the outlet refrigerant supply section. Advantageously, said portion interacts with the radial collar to facilitate the positioning and centering of the tubular element inside the outlet refrigerant supply section, simplifying the integration of the tubular element into the condenser and the related production process.

Advantageously, the tubular element comprises an end portion which protrudes with respect to the tubular element opening comprised in the plug portion suitable for closing the outlet refrigerant supply section. Advantageously, this configuration allows for obtaining a stable brazing joint between the plug portion and the outer surface of the tubular element, ensuring a stable and reliable integration of the tubular element itself in the condenser and the maintenance of the airtight separation between the condensation gap and the outlet refrigerant supply section required to ensure the correct operation of the condenser.

Advantageously, the tubular element comprises an end portion extending into the outlet refrigerant supply section. Said portion allows for distributing the refrigerant flow rate on the transverse sections of the outlet refrigerant region, maximizing the exploitation of the surface available for the heat exchange with the liquid.

Advantageously, the condenser is installable in a vertical position with the outlet refrigerant supply section positioned in a lower geodetic position with respect to the inlet refrigerant supply section and with the tubular element oriented in a substantially horizontal position with respect to the ground plane. Advantageously, in this embodiment, the integration of the tubular element in the outlet refrigerant supply section allows for maximizing the amount of liquid refrigerant exiting the condenser maintaining possible portions of refrigerant still in the gas phase in the upper part of the transverse sections.

Advantageously, the installation of the condenser in a vertical position and of the tubular element with the main axis oriented horizontally in a lower geodetic position with respect to to the inlet refrigerant supply section also allows for exploiting the gravity in the circulation of the refrigerant fluid inside the condenser, in particular, in the case of a possible stratification of the vapor phase and the liquid phase in the transverse refrigerant sections comprised in the condenser, and ensures an adequate circulation of the refrigerant fluid in the liquid phase towards the outlet mouth and ensures the control of the temperature of the components included in the cooling system.

Advantageously, any pressure drops introduced into the refrigerant circuit by the presence of the tubular element are compensated for by transverse refrigerant sections of greater height than the transverse liquid sections.

Advantageously, the liquid-cooled condenser is a single component.

It is apparent that, in order to meet contingent needs, a skilled person in the art may make changes to the above-described liquid-cooled condenser, all contained within the scope of protection as defined by the following claims.

### LIST OF REFERENCE NUMBERS

1 liquid-cooled condenser
21 refrigerant region
211 inlet refrigerant supply section
212 outlet refrigerant supply section
213 transverse refrigerant sections
213′inlet refrigerant region
213″ intermediate refrigerant region
213′″ outlet refrigerant region
2110 refrigerant inlet mouth
2120 refrigerant outlet mouth
22 liquid region
221 inlet liquid supply section
222 outlet liquid supply section
223 transverse liquid sections
2210 liquid inlet mouth
2220 liquid outlet mouth
3 upper plate-like end element
311, 312, 321, 322 vertical connection collar
38 recess
4 intermediate plate-like element
45, 45′plug portion
456 tubular element opening
5 lower plate-like end element
6 tubular element
68 radial collar
711 inlet refrigerant connection member
712 outlet refrigerant connection member
9 condensation gap
X-X, Y-Y transverse axes
V-V first axis

1. A liquid-cooled condenser, of a vehicle cooling system, adapted to carry out a condensation of a refrigerant fluid circulating in the cooling system by heat exchange with a liquid, comprising a refrigerant inlet mouth and a refrigerant outlet mouth through which the refrigerant fluid flows in and out, and a liquid inlet mouth and a liquid outlet mouth through which the liquid flows in and out, wherein the liquid-cooled condenser comprises:
upper and lower plate-like end elements, wherein said mouths are on said plate-like end elements;
a plurality of intermediate plate-like elements arranged between the plate-like end elements;
wherein the intermediate plate-like elements delimit, in mutual stacking, a refrigerant region, in which the refrigerant fluid flows, comprising refrigerant supply sections, inlet and outlet sections, respectively, in fluid communication with the refrigerant inlet mouth and with the refrigerant outlet mouth, and transverse refrigerant sections and a liquid region into which the liquid flows, comprising liquid supply sections inlet and outlet sections, respectively, in fluid communication with the liquid inlet mouth and the liquid outlet mouth, and transverse liquid sections positioned alternating with the transverse refrigerant sections;
wherein the liquid-cooled condenser comprises a tubular element extending into the outlet refrigerant supply section, wherein the transverse section of the tubular element is smaller than the transverse section of the outlet refrigerant supply section, forming a condensation gap.

2. The liquid-cooled condenser according to claim 1, wherein the tubular element extends along an axis, and the liquid-cooled condenser is positionable in a position in which the tubular element and the axis are parallel to a ground plane.

3. The liquid-cooled condenser according to claim 1, wherein the refrigerant fluid inside the tubular element flows in a liquid state towards the refrigerant outlet mouth, while the refrigerant fluid inside the condensation gap flows in an opposite direction, being at least partially in a gas state.

4. The liquid-cooled condenser according to claim 1, wherein the tubular element comprises a radial collar, wherein said radial collar is positioned between a plate-like end element and an intermediate plate-like element.

5. The liquid-cooled condenser according to claim 4, wherein the plate-like end element comprises a recess in which the radial collar is accommodated.

6. The liquid-cooled condenser according to claim 1, wherein at least one of the intermediate plate-like elements comprises a plug portion positioned transversely to an inlet refrigerant supply section to divert flow of the refrigerant fluid.

7. The liquid-cooled condenser according to claim 6, wherein at least one of the intermediate plate-like elements comprises a plug portion positioned transversely to an outlet refrigerant supply section so that, in the transverse refrigerant sections, an inlet refrigerant region, an intermediate refrigerant region, and an outlet refrigerant region are defined.

8. The liquid-cooled condenser according to claim 7, wherein the refrigerant fluid flows into the refrigerant region to have flows in opposite transverse directions between respective operating regions.

9. The liquid-cooled condenser according to claim 7, wherein the plug portion accommodated in the outlet refrigerant supply section comprises a tubular element opening through which the tubular element extends, wherein said plug portion has an annular shape when accommodated in the condensation gap.

10. The liquid-cooled condenser according to claim 7, wherein the tubular element extends along an axis beyond the plug portion into the outlet refrigerant supply section in fluid communication with the outlet refrigerant region.

11. The liquid-cooled condenser according to claim 6, wherein said plug portion is embedded, in one piece, in a respective intermediate plate-like element.

12. The liquid-cooled condenser according to claim 1, wherein the transverse refrigerant sections and/or the transverse liquid sections comprise respective tubular elements.

13. The liquid-cooled condenser according to claim 1, wherein the transverse refrigerant sections have a greater height than a height of the transverse liquid sections.

14. The liquid-cooled condenser according to claim 1, wherein the plate-like end elements, the intermediate plate-like elements, and the tubular element are mutually joined by brazing.

15. The liquid-cooled condenser according to claim 1, comprising inlet and outlet refrigerant connection members, and inlet and outlet liquid connection members, operatively connected to the plate-like end element at the refrigerant inlet mouth the refrigerant outlet mouth, the liquid inlet mouth and the liquid outlet mouth, wherein said connection members, said plate-like end elements, said intermediate plate-like elements, and said tubular element are mutually joined by a single brazing operation.

16. The liquid-cooled condenser according to claim 15, wherein the plate-like end element comprises a protruding connection collar, positioned around the refrigerant outlet mouth, which is engageable by the outlet refrigerant connection member.

17. The liquid-cooled condenser according to claim 15, wherein the plate-like end element comprises, around the refrigerant inlet mouth and the refrigerant outlet mouth, a respective protruding connection collar, which is engageable by a respective connection member.

18. The liquid-cooled condenser according to claim 1, wherein said mouths are all on the upper plate-like element.

19. The liquid-cooled condenser according to claim 1, wherein the tubular element extends along an axis, and the liquid-cooled condenser is positionable in a position in which the tubular element and the axis are parallel to a ground plane, and wherein the tubular element is in a lower geodetic position as compared to the inlet refrigerant supply section.

20. The liquid-cooled condenser according to claim 15, wherein the upper plate-like end element comprises a protruding connection collar, positioned around the refrigerant outlet mouth, which is engageable by the outlet refrigerant connection member.
